(19) United States
(12) Patent Application Publication
(10) Pub. No.: US 2009/0185276 A1
(43) Pub. Date: Jul. 23, 2009

(54) Display device

(76) Inventor: Tsutomu Matsuhira, Chiba-shi (JP)

Correspondence Address: BRUCE L. ADAMS, ESQ.;ADAMS & WILKS, SUITE 1231, 17 BATTERY PLACE, NEW YORK, NY, 10004, US

(21) Appl. No.: 12/317,441

(22) Filed: Dec. 23, 2008

(30) Foreign Application Priority Data
Dec. 27, 2007 (JP) 2007-336674
Dec. 5, 2008 (JP) 2008-310971

(51) Int. Cl. G02B 27/00

(52) U.S. Cl. 359/601

(57) ABSTRACT

Provided is a display device including a transparent board which forms a cover plate or the like on a display panel. In a case where an anti-reflection film is formed on a surface of the transparent board on a display viewing side thereof, a fingerprint, an oil film, and the like are liable to adhere thereto, and the soil due to the fingerprint and the oil film is noticeable on a surface of the anti-reflection film. Under the circumstances, on the surface of the transparent board on the display viewing side thereof, the anti-reflection film is formed, and a silicon oxide film for anti-soiling is formed on the anti-reflection film. With this structure, the fingerprint and the oil film are unlikely to adhere to the surface of the anti-reflection film, and are not noticeable even when adhering thereto.

### BACKGROUND OF THE INVENTION

1. Field of the Invention

The present invention relates to a display device in which a transparent board is disposed on a surface on a display viewing side of a display panel. Specifically, the present invention relates to a display device having a structure in which a cover plate or a touch panel is disposed on a surface of a display panel.

2. Description of the Related Art

In portable devices including a mobile phone, there is used a flat panel such as a liquid crystal panel, an organic electroluminescence (EL) panel, or a plasma display panel. In a case where the flat panel is used for the portable devices, a display panel is accommodated in a casing, and to a display screen side thereof, a front plate is attached to thereby protect a display screen. Further, in place of the front plate, a touch panel is disposed on a display viewing side in some cases (for example, see JP 09-274536 A)

However, in a case where the front plate or the touch panel is disposed on the surface of the display panel, display light output from the display panel is attenuated due to reflection on a surface of a transparent board which forms the front plate or the touch panel. In addition, external light is reflected on the surface of the transparent board, whereby the display visibility is reduced. Moreover, the display panel which is used in the portable devices needs to reduce power consumption, and hence, in addition to the reduction in power consumption for the display panel itself, it is necessary to efficiently output as much display light output from the display panel without attenuation as possible.

Under the circumstances, efforts are being made to reduce a reflection loss on the surface of the transparent board by forming an anti-reflection film on the surface thereof. On the other hand, in a case where the display panel is used in the portable devices, hands and fingers frequently touch the display screen when the portable devices are carried around. Further, depending on use environments, an oil film and other soil are liable to adhere to the display screen.

The anti-reflection film formed on the surface of the transparent board reduces the reflection loss on the surface of the board with use of light interference in the anti-reflection film, which increases a transmittance thereof. When the surface of the above-mentioned transparent board having high transmittance is soiled, the soil is noticeable. When a fingerprint, sweat, or an oil film of a user adheres to a surface of the anti-reflection film, a light interference condition of the adhesion portion is changed and the soil is more noticeable, resulting in reducing the display visibility.

### SUMMARY OF THE INVENTION

According to the present invention, there is provided a display device including: a display panel; a transparent board disposed on a display screen side of the display panel; an anti-reflection film formed on a surface on a display viewing side of the transparent board; and a silicon oxide film for anti-soiling formed on a surface of the anti-reflection film. Further, a gap between the display panel and the transparent board is filled with a transparent adhesive.

Further, a surface of the silicon oxide film is formed so as to have a contact angle with respect to water ranging from 80 degrees to 180 degrees. Moreover, the silicon oxide film is formed so as to have a hardness ranging from 6 H to 9 H in a pencil hardness.

In this case, a single layer film made of magnesium fluoride is used as the anti-reflection film. Further, the surface of the transparent board on a side on which the silicon oxide film is formed has a light transmittance ranging from 98% to 99%.

Here, the transparent board may be a board which forms a front plate, a board which forms a touch panel, or the like. An electrostatic capacitive coupling-type touch panel may be arranged between the transparent board which forms a front plate, and the display panel.

### BRIEF DESCRIPTION OF THE DRAWINGS

In the accompanying drawings:

FIG. 1 is a schematic cross-sectional view of a transparent board used in a display device according to the present invention;

FIG. 2 is a schematic cross-sectional view of the display device according to the present invention;

FIG. 3 is a schematic cross-sectional view of a display device according to the present invention; and

FIG. 4 is a schematic cross-sectional view of a display device according to the present invention.

### DETAILED DESCRIPTION OF THE PREFERRED EMBODIMENTS

In a display device according to the present invention, a front plate or a touch panel is disposed on a display screen side of a display panel. On a viewer side, an anti-reflection film is formed on a surface of a transparent board which is a constituent of the front plate or the touch panel, and an anti-soiling silicon oxide film for preventing soiling due to a fingerprint etc. is formed on a surface of the anti-reflection film. With this structure, the display device has an advantage that a fingerprint and an oil film are unlikely to adhere to the surface and are not noticeable even when a fingerprint and soil adhere thereto.

As the display panel, there are exemplified flat display panels such as a liquid crystal panel, an organic electroluminescence (EL) panel, and a plasma display panel. As the transparent board used in the front plate and the like, there are exemplified boards made of glass or a plastic material such as an acrylic resin (polymethyl methacrylate (PMMA)) or a polycarbonate resin. As the anti-reflection film, a magnesium fluoride film may be used. The magnesium fluoride film of a single layer, or a multi-layer structure in combination of the magnesium fluoride film with other dielectric materials may be used as the anti-reflection film. Note that it is advantageous to use the magnesium fluoride film of a single layer from the viewpoint of cost.

For the silicon oxide film, a silicon dioxide film, a silicon monoxide film, or SiOₓ (1<x<2) can be used. The silicon oxide film can be formed by sputtering in which a silicon oxide is used as a target or by reactive sputtering in which a silicon oxide or a silicon substrate is used as a target in an oxygen atmosphere. Further, a silicon oxide film can be formed by chemical vapor deposition (CVD) or plasma CVD using a silane gas and an oxygen gas.

Further, a gap between the display panel and the transparent board can be filled with a transparent adhesive. As the transparent adhesive, there is used a UV-curing adhesive, a visible light-curing adhesive, a heat curing adhesive, or a transparent adhesive sheet. A refractive index of the transparent adhesive is made approximate to that of the transparent board or that of a material of the surface of the display panel, whereby a reflection loss of display light output from the display panel on the surface of the transparent board or of the display panel can be reduced. Moreover, the transparent board and the display panel are integrated with each other by the transparent adhesive, and hence a shock resistance of the display panel is improved.

Further, a contact angle of a surface of the silicon oxide film with respect to water is set to a range of from 80 degrees to 180 degrees. As a result, the surface of the transparent board is provided with water repellency, and hence a fingerprint, sweat, an oil film, and the like are unlikely to adhere to the surface. For example, in a case where the magnesium fluoride film is exposed as the anti-reflection film, the contact angle with respect to water is 30 degrees or less. Through the formation of the silicon oxide film on the surface, the surface can be changed into a surface with water repellency, and therefore the surface is unlikely to be soiled. A pencil hardness of the surface of the silicon oxide film is set to a range of from 6 H to 9 H. Accordingly, the display screen has a high hardness and thus becomes resistant to scratches. The contact angle of the surface of the silicon oxide film with respect to water may be set to a range of from 80 degrees to 180 degrees, and the pencil hardness of the surface thereof may be set to a range of from 6 H to 9 H.

Further, there can be arranged an electrostatic capacitive coupling-type touch panel between the transparent board which forms a front plate, and the display panel. This enables input of information from the display screen side. In particular, the electrostatic capacitive coupling-type touch panel does not have a surface such as an air layer within the touch panel. Therefore, in a case where the touch panel is applied to a display device, a reflection loss of the display light can be reduced.

Hereinafter, the present invention is described in detail based on embodiments of the present invention. The embodiments of the present invention use a liquid crystal panel as a display panel. Basically, like portions and portions having like functions are denoted by like reference numerals.

### First Embodiment

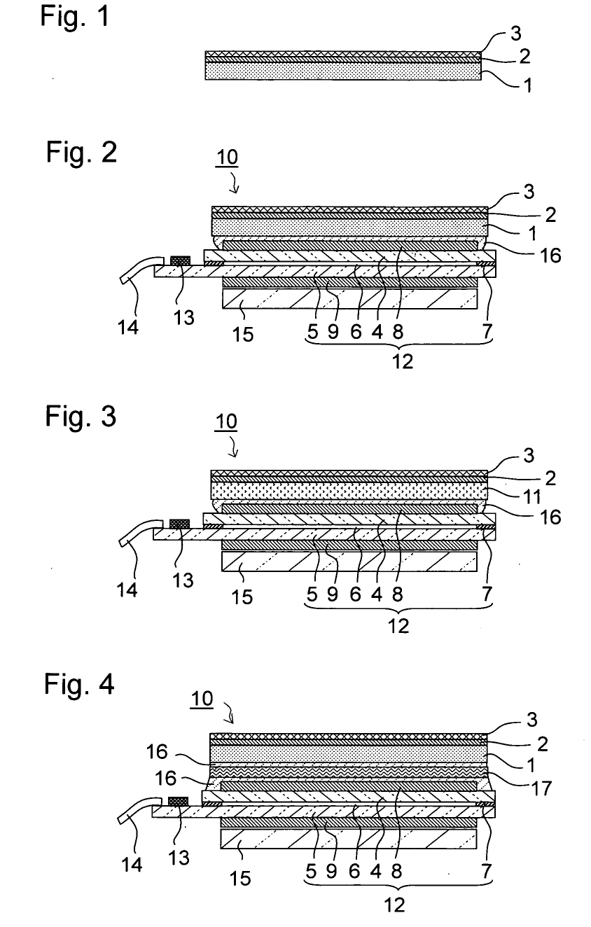

FIG. 1 is a schematic cross-sectional view illustrating a front plate of a display device according to this embodiment. The front plate has a structure in which, on a surface of a transparent board 1, an anti-reflection film 2 is formed, and on a surface thereof, a silicon oxide film 3 is formed. As the transparent board 1, glass is used. The anti-reflection film 2 is formed of magnesium fluoride (MgF₂) by sputtering to have a single layer. As the silicon oxide film 3, a silicon dioxide film is deposited with a thickness of 1,050 Å by sputtering. Note that the thickness of the silicon oxide film 3 is not limited thereto, and may be set to about ½ or less of a wavelength of visible light, for example, from several hundred Å to 2,000 Å.

When a transmittance of a surface of a side on which the silicon oxide film 3 is formed is determined, the transmittance of the visible light is 98.5%. When a transmittance of the surface is determined when the anti-reflection film 2 has been formed before the silicon oxide film 3 is deposited, the transmittance is 96.1%. In other words, the transmittance is improved by 2.4% owing to the formation of the silicon oxide film 3. The surface of the silicon oxide film 3 is provided with a pencil hardness of 6 H or more. Accordingly, a surface which is resistant to scratches can be obtained.

Further, with regard to wettability of the surface of the silicon oxide film 3, a contact angle with respect to water is 98 degrees, and a contact angle with respect to oleic acid is 61 degrees. The contact angle of the anti-reflection film 2, which is formed of the magnesium fluoride film, before the silicon oxide film 3 is deposited, is 24 degrees with respect to water, and is 20 degrees with respect to the oleic acid. In other words, the deposition of the silicon oxide film 3 allows the surface to be changed into a surface with water repellency.

FIG. 2 schematically illustrates a cross-sectional structure of a liquid crystal display device 10 of this embodiment. As illustrated in FIG. 2, the liquid crystal display device 10 includes the transparent board 1, a liquid crystal panel 12, and a backlight 15. In the liquid crystal panel 12, a liquid crystal layer 6 is sealed with a sealing material 7 between an upper substrate 4 and a lower substrate 5 which are made of glass, and there are attached an upper polarizing plate 8 to an external surface of the upper substrate 4, and a lower polarizing plate 9 to an external surface of the lower substrate 5. The lower substrate 5 protrudes from the upper substrate 4, and onto an inner surface side of the protruding portion, a driver IC 13 for driving the liquid crystal layer 6 is mounted. Further, a flexible connector 14 for transmitting a drive signal to the driver IC 13 is connected to the protruding portion.

The transparent board 1 and the liquid crystal panel 12 are bonded to each other by a transparent adhesive 16. As the transparent adhesive 16, a UV-curing adhesive or a visible light-curing adhesive is used. The UV-curing adhesive or the visible light-curing adhesive is unnecessary to be heated and has a smaller cure shrinkage ratio compared with a heat curing adhesive. Accordingly, a stress applied to the liquid crystal layer 6 due to deterioration of the upper polarizing plate 8 and the lower polarizing plate 9 and cure shrinkage of the adhesive can be reduced. The transparent adhesive 16 obtained by adding the heat curing adhesive to a photo-curing adhesive may be used. The liquid crystal panel 12 is fixed to the transparent board 1 with the transparent adhesive 16, whereby a shock resistance of the liquid crystal panel 12 is improved.

Here, a refractive index of the transparent adhesive 16 is set to, for example, 1.50 to 1.55. The refractive index of the transparent adhesive 16 is made approximate to that of the transparent board 1 or of the upper polarizing plate 8, whereby there can be reduced a reflection loss of light on a boundary between a lower surface of the transparent board 1 and the transparent adhesive 16 or on a boundary between the upper polarizing plate 8 and the transparent adhesive 16.

Note that, in FIG. 2, the liquid crystal panel 12 may be used with the upper surface and the lower surface turned upside down. The liquid crystal panel 12 may be a passive matrix liquid crystal panel or may be an active matrix liquid crystal panel in which a thin film transistor (TFT) element is formed in each pixel. Whatever type of liquid crystal maybe used. Further, the backlight 15 is disposed in a lower portion of the liquid crystal display device 10, but between the backlight 15 and the liquid crystal panel 12, a diffusion plate or a prism sheet for controlling a direction of light which is output from the backlight 15 can be inserted. Further, as the backlight 15, there can be used an electroluminescence (EL) light emitting sheet or one in which a light emitting diode (LED) is disposed in an end portion thereof to guide light in an upper direction by means of a light guide plate.

Further, FIG. 2 illustrates the structure in which the upper polarizing plate 8 is attached on the upper substrate 4. However, the upper polarizing plate 8 may be attached to a surface of the transparent board 1 on a liquid crystal panel 12 side thereof. An anti-glare ¼ wavelength plate may be disposed on a surface of the upper polarizing plate 8 or the surface of the transparent board 1 on the liquid crystal panel 12 side thereof.

With the structure of the liquid crystal display device 10 described above, the reflection loss on the surface of the transparent board 1 on a display viewing side thereof is reduced. Further, an air layer is not interposed between the liquid crystal panel 12 and the transparent board 1, and the refractive index of the transparent adhesive 16 is made approximate to those of both the upper substrate 4 and the transparent board 1, whereby there can be largely reduced the reflection loss of display light output from the liquid crystal panel 12. Further, an exposed surface of the liquid crystal display device 10 is made to be a surface with water repellency, whereby a fingerprint etc. are unlikely to adhere to the exposed surface. Moreover, a fingerprint etc. are not noticeable even when adhering to the exposed surface. In addition, the pencil hardness of the silicon oxide film 3 is set to 6 H or more. Accordingly, the exposed surface is resistant to scratches or the like.

In this embodiment, the transparent board 1 has been described as a constituent of the front plate, but the same holds basically true for a case of a transparent board which forms a touch panel. The structure of a liquid crystal display device in this case is schematically illustrated in FIG. 3. As described above, on a viewer side of the transparent board which forms an input element 11 such as a touch panel or a touch switch, the anti-reflection film 2 and the anti-soiling silicon oxide film 3 are sequentially formed, and the resultant transparent board is attached to the liquid crystal panel with the transparent adhesive 16.

### Second Embodiment

FIG. 4 schematically illustrates a cross-sectional structure of a liquid crystal display device 10 according to this embodiment. The liquid crystal display device 10 is different from the liquid crystal display device 10 of FIG. 2 in that an electrostatic capacitive coupling-type touch panel is inserted between a liquid crystal panel 12 and a transparent board 1 which forms a front plate. Other structures are similar to those of FIG. 2, and hence descriptions thereof are omitted.

The transparent board 1 and a touch panel 17 are bonded to each other with a transparent adhesive 16. Similarly, the touch panel 17 and the liquid crystal panel 12 are bonded to each other with the transparent adhesive 16. In the electrostatic capacitive coupling-type touch panel 17, a transparent conductive film is formed on a surface of a transparent board such as glass. When a user touches, with a finger or the like, a surface on a side opposite to the surface on which the transparent conductive film is formed, a capacity between a touched portion and the transparent conductive film changes. A current variation accompanying this capacity change is two-dimensionally detected to thereby calculate a position at which a finger or the like has touched. Accordingly, unlike a resistive touch panel, this touch panel is unnecessary to interpose an air layer, whereby a thin touch panel in which a reflection loss of light on a surface thereof is reduced can be incorporated.

In this case as well, a refractive index of the transparent adhesive 16 and a refractive index of a glass board of the touch panel are made approximate to each other, whereby the reflection loss of light on the surface of the touch panel can be reduced. Further, on a surface of the transparent board 1, an anti-reflection film 2 is formed, and thereon, a silicon oxide film 3 serving as an anti-soiling film is formed. Accordingly, a fingerprint. and the like are unlikely to adhere to the surface, and it is possible to prevent a poor display.

As in the structures according to the embodiments described above, the anti-reflection film and the silicon oxide film are sequentially formed on the surface of the transparent board which is exposed to the outside. As a result, the surface is unlikely to be soiled, and the soil is not noticeable even when adhering thereto, whereby a poor display can be prevented.

What is claimed is:

1. A display device, comprising:
a transparent board disposed on a display screen side of a display panel;
an anti-reflection film formed on a surface on a display viewing side of the transparent board; and
a silicon oxide film for anti-soiling formed on a surface of the anti-reflection film.

2. A display device according to claim 1, wherein a gap between the display panel and the transparent board is filled with a transparent adhesive.

3. A display device according to claim 1, wherein a surface of the silicon oxide film has a contact angle with respect to water ranging from 80 degrees to 180 degrees.

4. A display device according to claim 1, wherein the silicon oxide film has a pencil hardness ranging from 6 H to 9 H.

5. A display device according to claim 1, wherein the anti-reflection film comprises a single layer film made of magnesium fluoride.

6. A display device according to claim 1, wherein the surface of the transparent board on a side on which the silicon oxide film is formed has a light transmittance ranging from 98% to 99%.

7. A display device according to claim 6, further comprising an electrostatic capacitive coupling-type touch panel sandwiched between the transparent board and the display panel.

8. A display device according to claim 7, wherein the transparent board comprises a board which forms a front plate.
